(19) United States
(12) Patent Application Publication
(10) Pub. No.: US 2006/0065592 A1
(43) Pub. Date: Mar. 30, 2006

(54) Direct flow filter with sealing mechanism

(76) Inventors: Mark A. Terres, Stoughton, WI (US); Eric A. Janikowski, Jefferson, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/952,622

(22) Filed: Sep. 29, 2004

(51) Int. Cl. B01D 46/40

(52) U.S. Cl. 210/493.1; 210/493.5; 55/497; 55/521

(57) ABSTRACT

A direct flow filter has seal tips alternately sealing upstream and/or downstream ends of wall segments to each other to define first and second sets of flow channels and protecting the ends of the wall segments from damage, including upstream ends from incoming debris, and providing structural support withstanding high flow rates and improving flow by means of the geometry of the seal.

### BACKGROUND AND SUMMARY

The invention relates to fluid filters, and more particularly to direct flow filters.

The invention arose during continuing development efforts relating to direct flow filters. The filtration industry, including for automotive application, is driven towards more efficient space utilization, e.g. eliminating large open areas within a filter element and/or within a filter housing between the filter element and the housing, which is particularly desirable in space constrained areas such as behind the cabin or under the hood of vehicles. Direct flow filters are effective for this purpose. A direct flow filter filters fluid flowing along an axial flow direction and includes a pleated filter element having a plurality of pleats defined by wall segments extending along a transverse direction between first and second sets of pleat tips at first and second sets of axially extending bend lines, the transverse direction being perpendicular to the axial direction. In a direct flow filter, fluid to be filtered flows axially into the channels, parallel to the noted bend lines.

In the prior art, the upstream and downstream ends of the wall segments are alternately sealed to each other by applying hot melt adhesive to the pleats during the pleating process. This presents manufacturing challenges because the hot melt must be applied to both the top and bottom surfaces of the media during pleating. After pleating and sealing of the edges to each other, a later operation seals the pleat block into the filter housing structure.

A drawback of the noted hot melt sealing is variation in thickness, which is due to many variables. The result is a leading and/or trailing edge which varies in thickness and can increase restriction, which is undesirable in a filter.

A further disadvantage of hot melt sealing is that the edges of the filter media are exposed to damage, including leading edges from incoming debris, or other physical contact. If leading and/or trailing edges are damaged, filter restriction can increase and/or a leak path could be created.

A further disadvantage of hot melt sealing is that the pleats are subject to tipping and bending and otherwise becoming misaligned. This misalignment results in non-uniform flow through the filter channels. In the case of a plurality of panels of pleated filter elements forming modules, the panels are subject to flexing and twisting, which in turn increases difficulty of assembly into a sturdy bank of filter elements.

The present invention addresses and solves the above noted and other problems in a particularly simple and effective manner.

### BRIEF DESCRIPTION OF THE DRAWING

### Prior Art

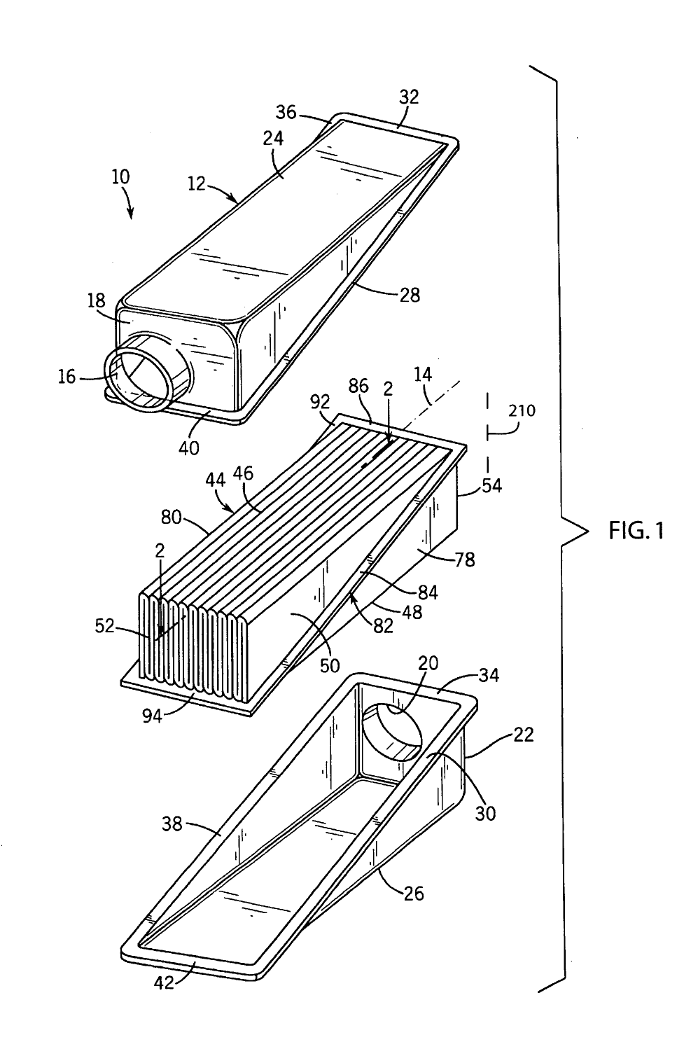

FIGS. 1-10 are taken from FIGS. 1, 2, 16-23, respectively, of U.S. Pat. No. 6,482,247, incorporated herein by reference.

FIG. 1 is an exploded perspective view of a filter.

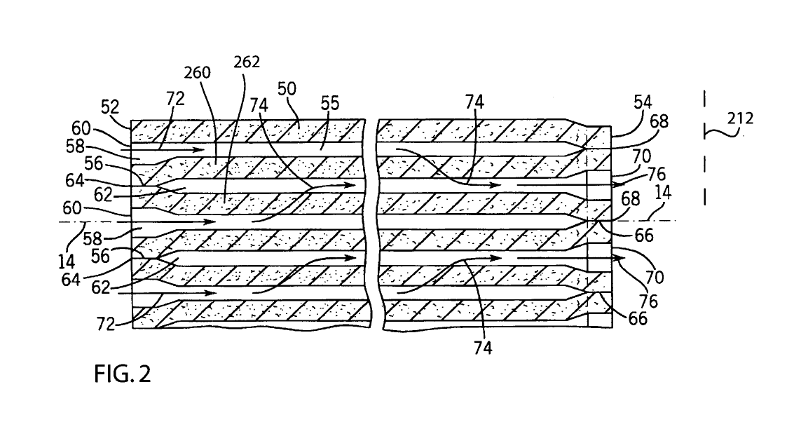

FIG. 2 is a sectional view taken along line 2-2 of FIG. 1.

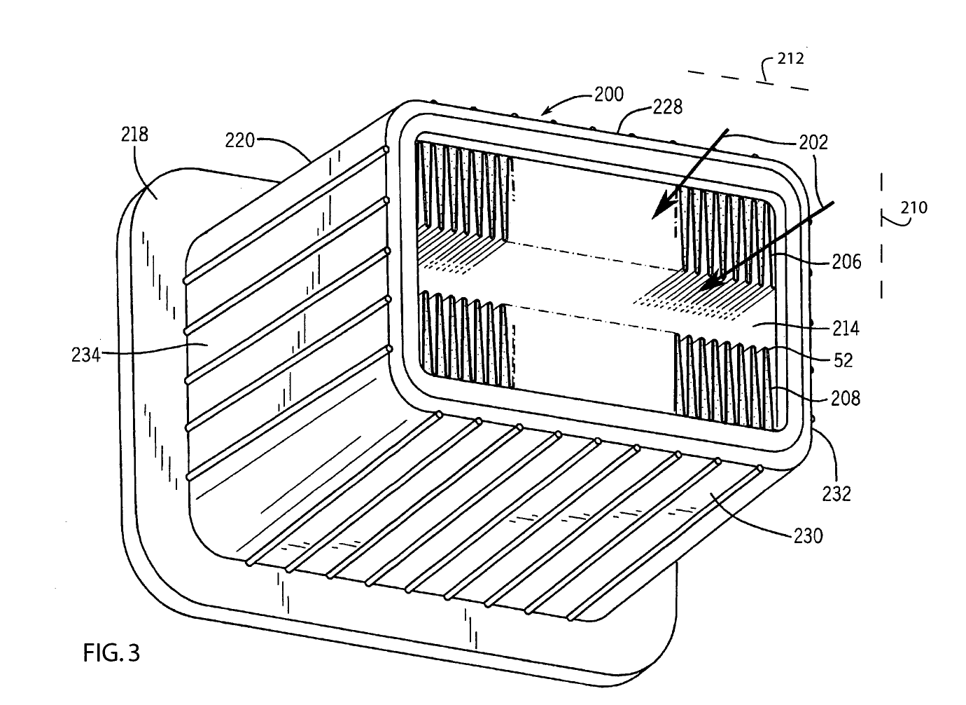

FIG. 3 is a perspective view showing the inlet end of a filter.

FIG. 4 is a perspective view showing the outlet end of the filter of FIG. 3.

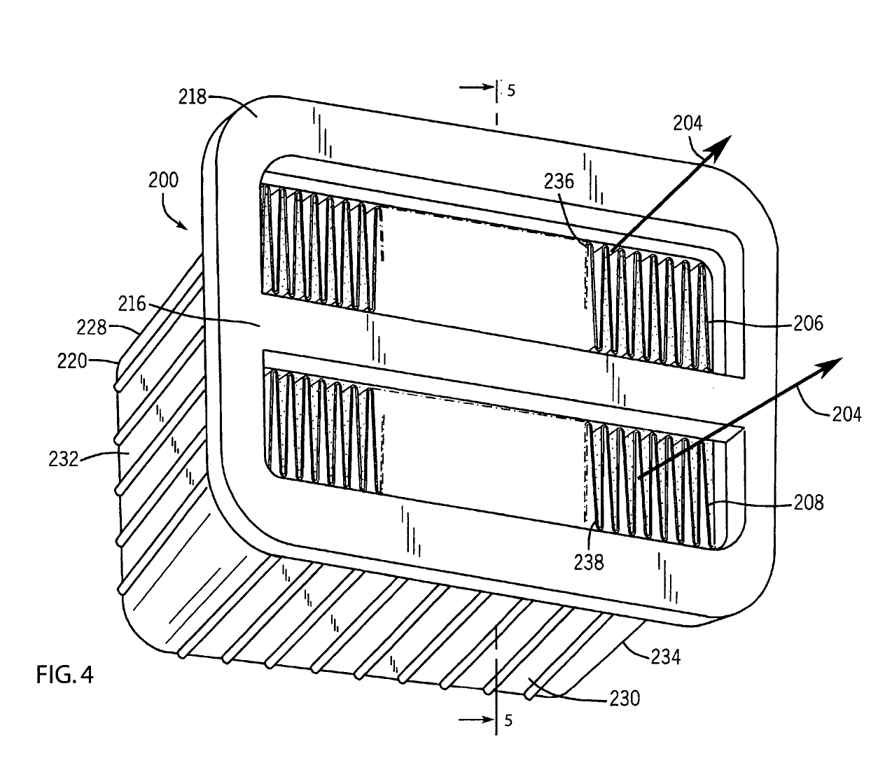

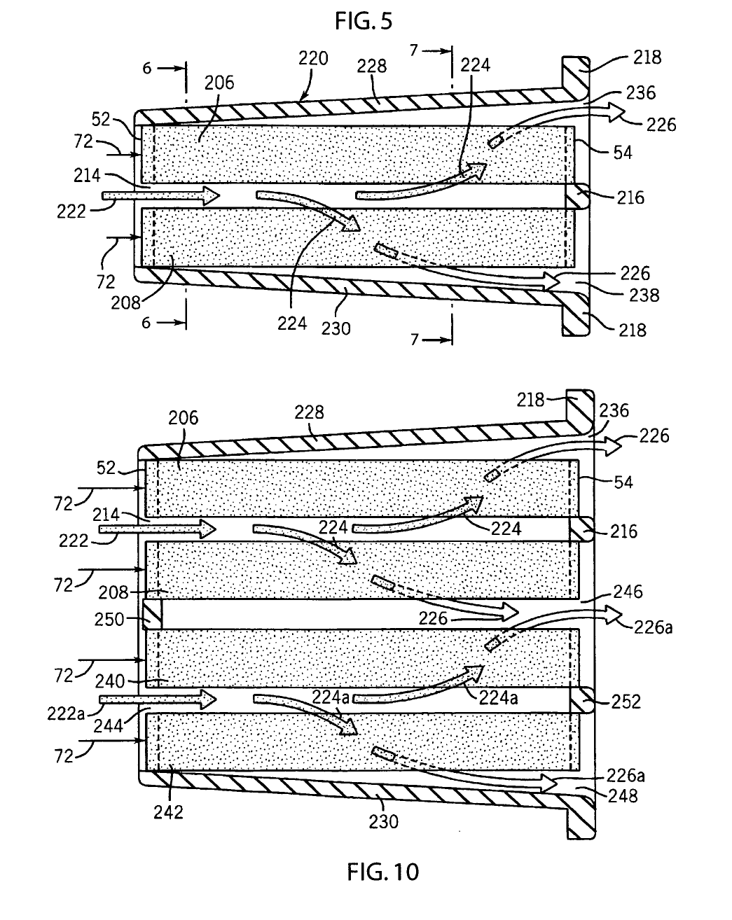

FIG. 5 is a sectional view taken along line 5-5 of FIG. 4.

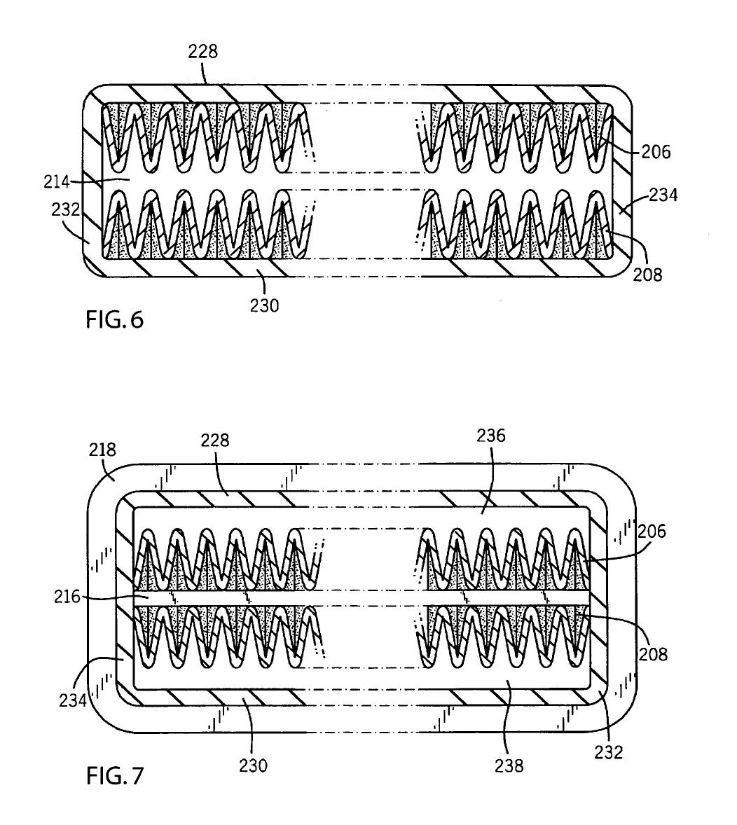

FIG. 6 is a sectional view taken along line 6-6 of FIG. 5.

FIG. 7 is a sectional view taken along line 7-7 of FIG. 5.

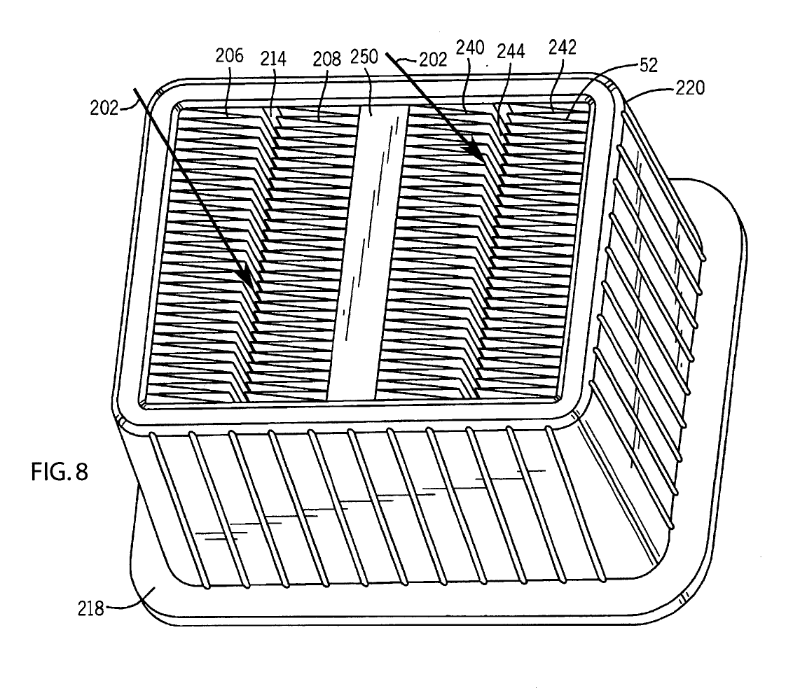

FIG. 8 is a perspective view showing the inlet end of an alternate embodiment of a filter.

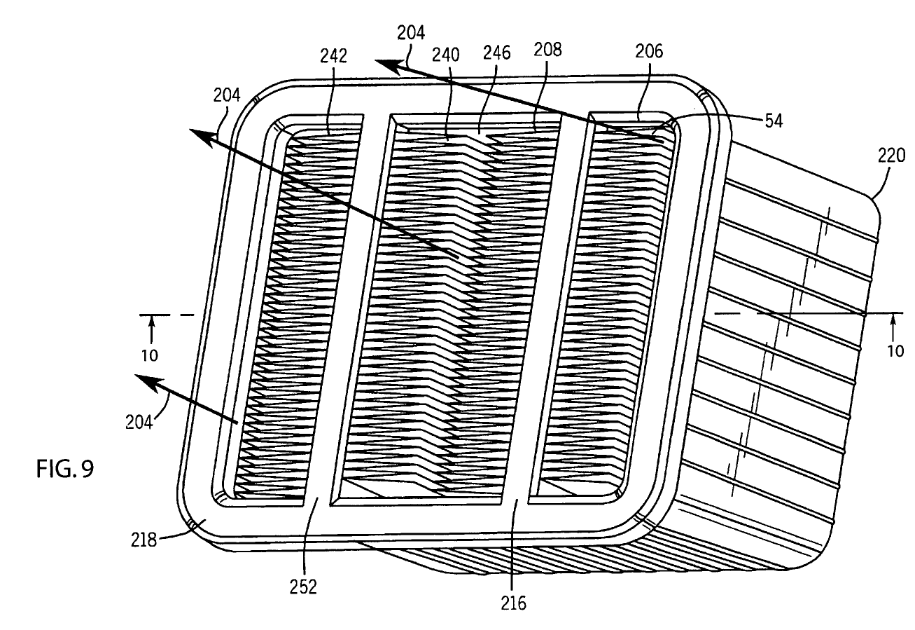

FIG. 9 is a perspective view showing the outlet end of the filter of FIG. 8.

FIG. 10 is a sectional view taken along line 10-10 of FIG. 9.

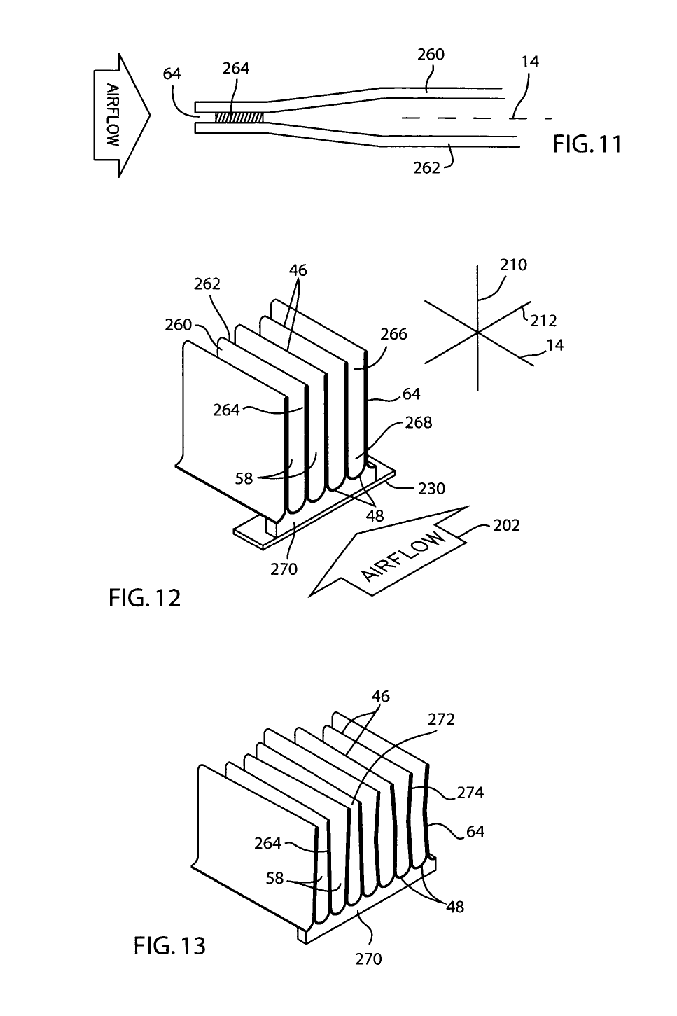

FIG. 11 is a view like a portion of FIG. 2.

FIG. 12 is a perspective view like a portion of FIG. 1.

FIG. 13 is like FIG. 12 and illustrates various misalignments.

### Present Invention

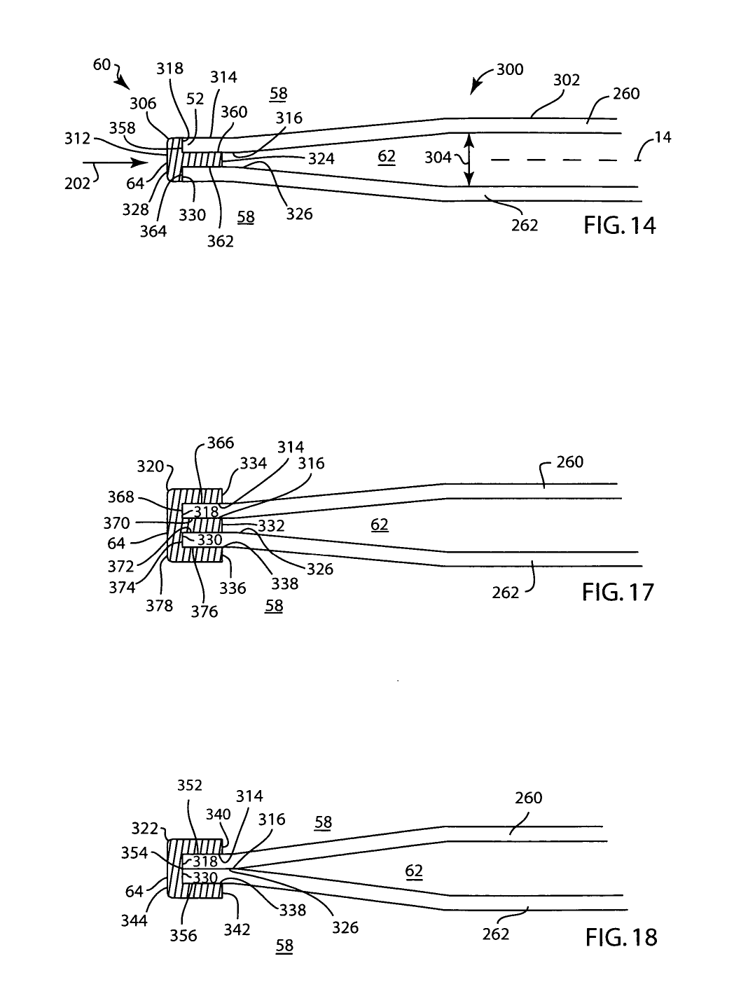

FIG. 14 is like FIG. 11 and illustrates the present invention.

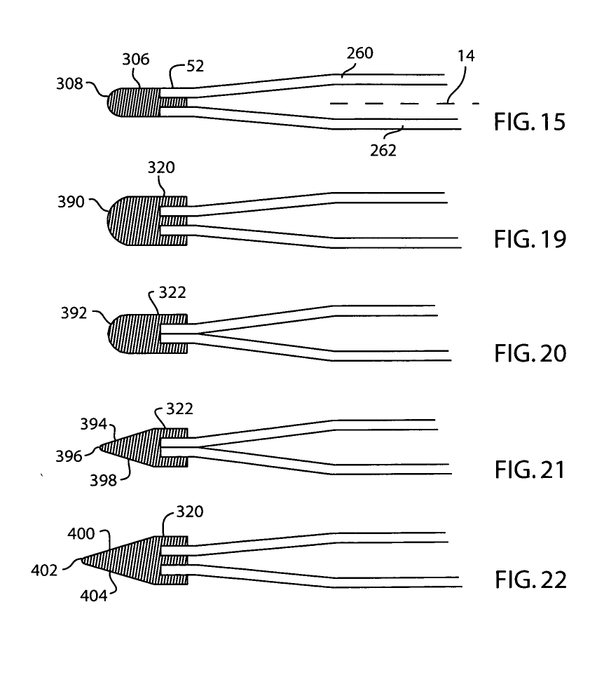

FIG. 15 is like FIG. 14 and shows a further embodiment.

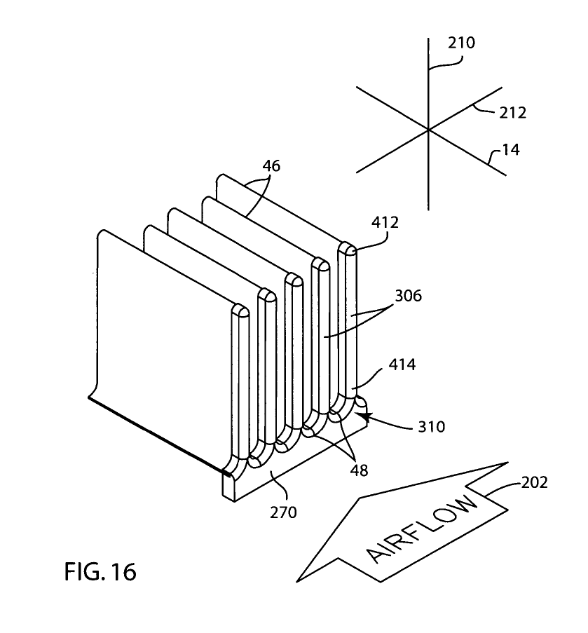

FIG. 16 is like FIG. 12 and shows the embodiment of FIG. 15.

FIG. 17 is like FIG. 14 and shows a further embodiment.

FIG. 18 is like FIG. 14 and shows a further embodiment.

FIG. 19 is like FIG. 17 and shows a further embodiment.

FIG. 20 is like FIG. 18 and shows a further embodiment.

FIG. 21 is like FIG. 18 and shows a further embodiment.

FIG. 22 is like FIG. 17 and shows a further embodiment.

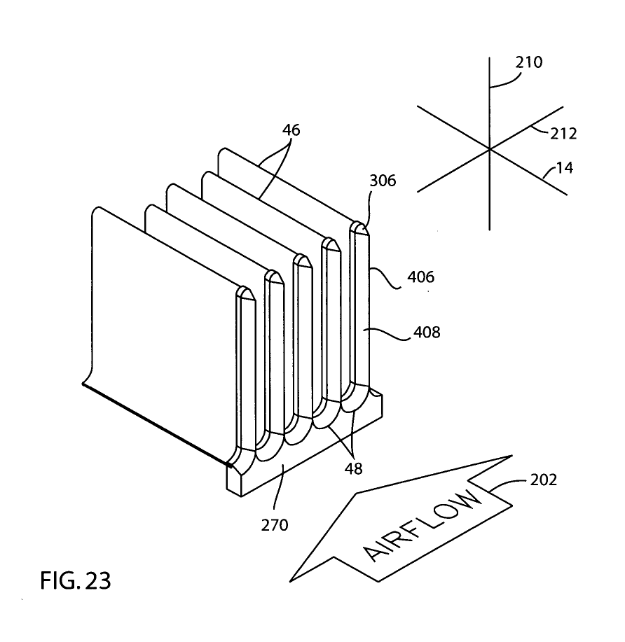

FIG. 23 is like FIG. 16 and shows the embodiment of FIG. 21.

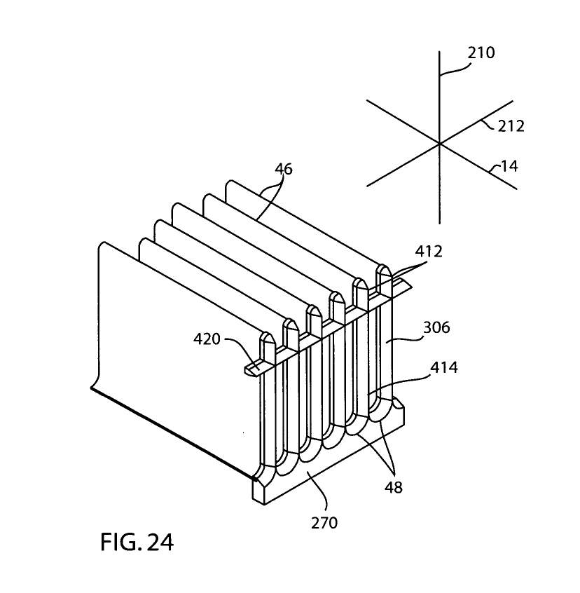

FIG. 24 is like FIG. 23 and shows a further embodiment.

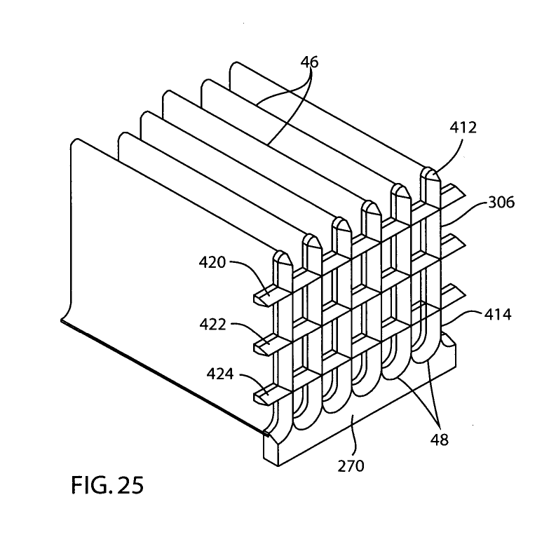

FIG. 25 is like FIG. 23 and shows a further embodiment.

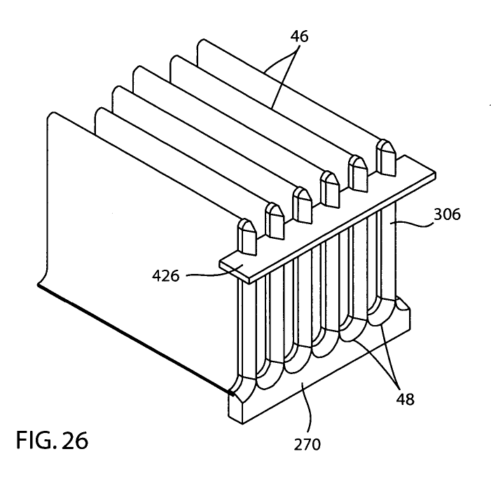

FIG. 26 is like FIG. 23 and shows a further embodiment.

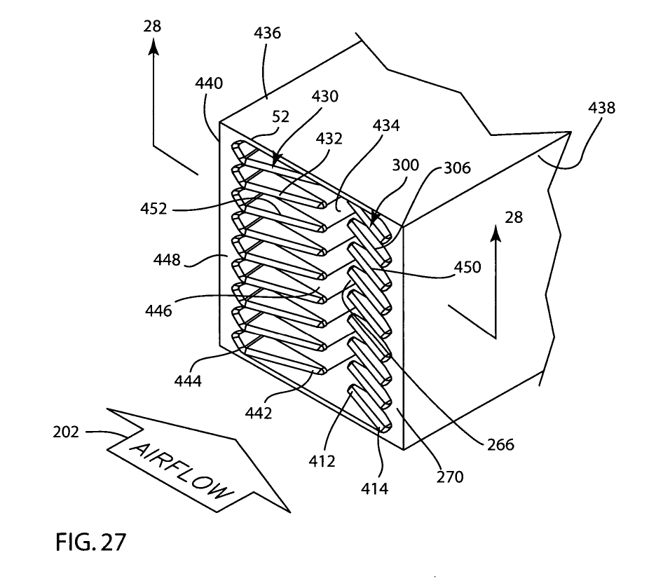

FIG. 27 is a perspective view similar to FIG. 3 and illustrates the present invention.

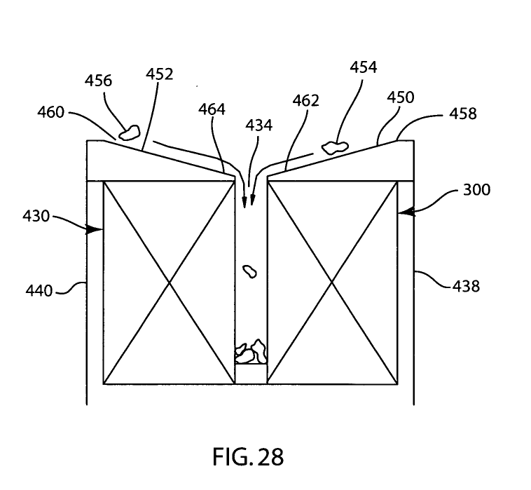

FIG. 28 is a sectional view taken along line 28-28 of FIG. 27.

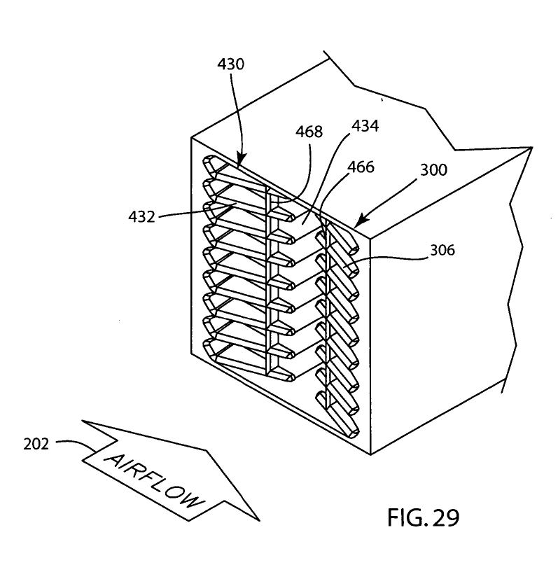

FIG. 29 is a view like FIG. 27 and shows a further embodiment.

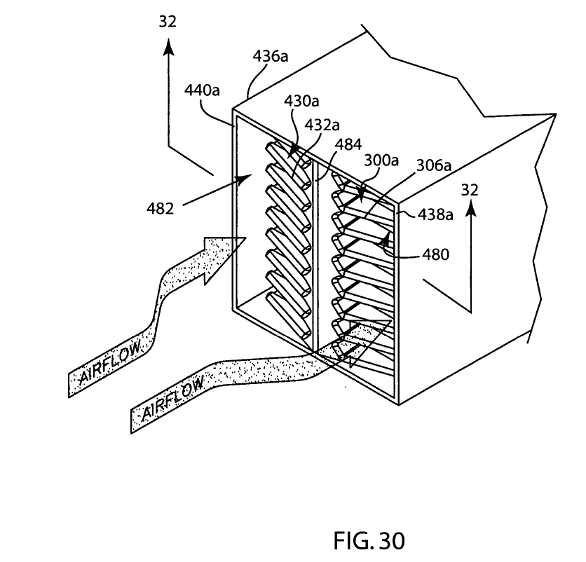

FIG. 30 is like FIG. 27 and shows a further embodiment.

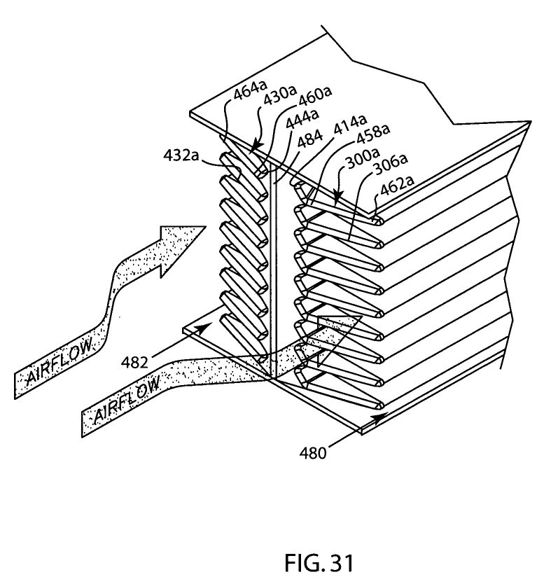

FIG. 31 is like FIG. 30 with a portion of the housing removed.

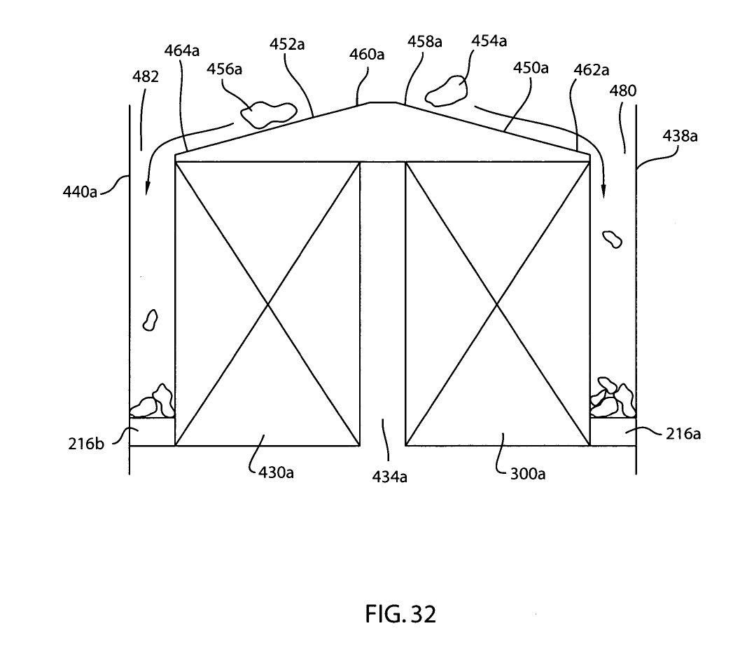

FIG. 32 is like FIG. 28 and is a sectional view taken along line 32-32 of FIG. 30.

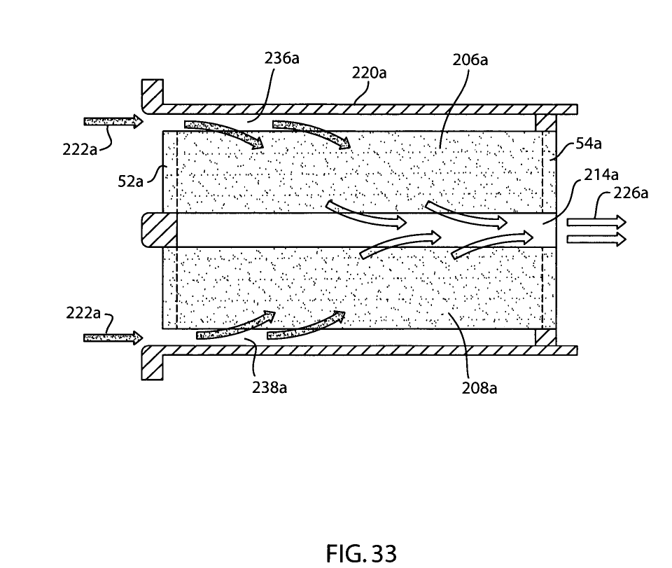

FIG. 33 is like FIG. 5 and shows a further embodiment.

### DETAILED DESCRIPTION

### Prior Art

The following description of FIGS. 1-10 is taken from incorporated U.S. Pat. No. 6,482,247 regarding FIGS. 1, 2, 16-23, respectively.

FIG. 1 shows a filter 10 including a housing 12 extending axially along axis 14 and having an inlet 16 at one axial end 18 of the housing and having an outlet 20 at a distally opposite axial end 22 of the housing. The housing is preferably plastic and provided by identical upper and lower half sections 24 and 26 mating along diagonal flanges 28, 30, lateral flanges 32, 34, diagonal flanges 36, 38, and lateral flanges 40, 42.

A pleated filter block is provided by pleated filter element 44 in the housing. The pleated filter element is pleated along a plurality of upper bend lines 46 and lower bend lines 48, which bend lines extend axially. The filter element has a plurality of wall segments 50 extending in serpentine manner between the upper and lower bend lines. The wall segments extend axially between upstream ends 52 at inlet 16, and downstream ends 54 at outlet 20. The wall segments define axial flow channels 55 therebetween, FIG. 2. The upstream ends of the wall segments are alternately sealed to each other, as shown at 56 in FIG. 2, to define a first set of flow channels 58 having open upstream ends 60, and a second set of flow channels 62 interdigitated with the first set of flow channels 58 and having closed upstream ends 64. The downstream ends 54 of wall segments 50 are alternately sealed to each other, as shown at 66 in FIG. 2, such that the first set of flow channels 58 have closed downstream ends 68, and the second set of flow channels 62 have open downstream ends 70. Fluid to be filtered, such as air, flows substantially directly axially through filter element 44, namely from inlet 16 through open upstream ends 60 of the first set of flow channels 58 as shown at arrows 72, then through wall segments 50 as shown at arrows 74, then through open downstream ends 70 of the second set of flow channels 62 as shown at arrows 76, then to outlet 20. It is preferred that at least a portion of each inlet 16 and outlet 20 are axially aligned.

Filter element 44 has laterally distally opposite right and left axially extending sides 78 and 80, FIG. 1, defining first and second axially extending planes. The second axial plane at side 80 is parallel to and spaced from the first axial plane at side 78. Upper bend lines 46 provide a first or upper set of coplanar bend lines defining a third axially extending plane. Lower bend lines 48 define a lower or second set of coplanar bend lines defining a fourth axially extending plane. The fourth axial plane at lower bend lines 48 is parallel to and spaced from the third axial plane at upper bend lines 46. The third and fourth axial planes are perpendicular to the noted first and second axial planes. Upstream ends 52 of wall segments 50 define a first laterally extending plane, and downstream ends 54 of the wall segments define a second laterally extending plane. The second lateral plane at downstream ends 54 is parallel to and spaced from the first lateral plane at upstream ends 52. The noted first and second lateral planes are perpendicular to the noted first and second axial planes and perpendicular to the noted third and fourth axial planes.

A gasket 82 is provided for sealing filter 44 to housing 12, including at gasket sections 84, 86, 92, 94, as described in the '247 patent, such that air entering inlet 16 cannot bypass the filter element to outlet 20, and instead must flow through the filter element as shown at arrows 72, 74, 76, FIG. 2. Further embodiments of the gasket are shown in the incorporated '247 patent at 82a, 82b, 82c.

FIGS. 3 and 4 show a filter 200 for filtering fluid flowing along an axial flow direction 14, FIGS. 1, 2, as shown at inlet flow arrows 202, FIG. 3 and outlet flow arrows 204, FIG. 4. The filter has a pair of panels or rows of pleated filter elements 206 and 208. Each filter element has a plurality of pleats defined by wall segments 50, FIGS. 1, 2, extending along a transverse direction 210 between first and second sets of pleat tips at first and second sets of axially extending bend lines 46 and 48. Transverse direction 210 is perpendicular to axial direction 14. Each of the panels 206 and 208 extends along a lateral direction 212 perpendicular to axial direction 14 and perpendicular to transverse direction 210. Wall segments 50 extend axially between upstream and downstream ends 52 and 54. The wall segments define axial flow channels 55 therebetween. The upstream ends of the wall segments are alternately sealed to each other, as shown at 56 in FIG. 2, to define a first set of flow channels 58 having open upstream ends 60, and a second set of flow channels 62 interdigitated with the first set of flow channels 58 and having closed upstream ends 64. The downstream ends 54 of wall segments 50 are alternately sealed to each other, as shown at 66 in FIG. 2, such that the first set of flow channels 58 have closed downstream ends 68, and the second set of flow channels 62 have open downstream ends 70. Fluid to be filtered, such as air, flows substantially directly axially through the filter element 44 of each of the panels 206, 208, through open upstream ends 60 of the first set of flow channels 58 as shown at arrows 72, FIG. 2, then through wall segments 50 as shown at arrows 74, then through open downstream ends 70 of the second set of flow channels 62 as shown at arrows 76.

Panels 206 and 208 have a transverse gap 214, FIG. 3, therebetween at upstream end 52, and are sealed to each other at downstream end 54 by sealing strip 216 which may be part of cover flange 218 at the downstream end of filter housing 220. Gap 214 provides additional fluid flow axially therethrough as shown at arrow 222, FIG. 5, i.e. fluid flows axially through the filter as described above and shown at arrows 72, 74, 76, FIG. 2, and additionally flows through the filter as shown at arrows 222, 224, 226, FIG. 5. Housing 220 includes laterally extending sidewalls 228 and 230 generally parallel to panels 206 and 208 and spaced transversally on distally opposite sides thereof. Housing 220 also includes sidewalls 232 and 234 extending transversely between lateral sidewalls 228 and 230. Sidewalls 228 and 230 are preferably slightly tapered outwardly away from each other from upstream end 52 to downstream end 54 and are sealed at their upstream ends to respective panels 206, 208, and have transverse gaps 236, 238 formed between sidewalls 228, 230 and respective panels 206, 208 at the downstream end providing the noted additional fluid flow 226 axially therethrough. In one embodiment, the filter panels are sealed to the housing by adhesive, and in another embodiment, the filter panels are sealed to the housing by a gasket as above described. In a further embodiment, the flow direction may be reversed such that incoming fluid flow enters the filter at end 54 through flow channels 70 and gaps 236, 238, and exits the filter at end 52 through flow channels 58 and gap 214.

FIGS. 8-10 show a further embodiment and a use like reference numerals from above where appropriate to facilitate understanding. First, second, third and fourth panels or rows 206, 208, 240, 242 of pleated filter elements 44 are provided. Two transverse gaps 214, 244 are provided between panels at upstream end 52, and one transverse gap 246 is provided between panels at downstream end 54. An additional downstream transverse gap 236, FIG. 10, is provided between housing sidewall 228 and panel 206, and another downstream transverse gap 248 is provided between panel 242 and housing sidewall 230. Transverse gap 214 is between panels 206 and 208. Transverse gap 244 is between panels 240 and 242. Transverse gap 246 is between panels 208 and 240. The transverse gap between panels 208 and 240 at upstream end 52 is closed and blocked at the upstream end by sealing strip 250 which may be part of the upstream end of the filter housing. The gap between panels 206 and 208 at downstream end 54 is blocked and closed by sealing strip 216, and the gap between panels 240 and 242 at downstream end 54 is blocked and closed by sealing strip 252, which sealing strips 216 and 252 may be part of cover flange 218 at the downstream end of the housing. Fluid flows axially through the filter as shown at arrows 72, 74, 76, FIG. 2. Fluid additionally flows through the filter, FIG. 10, as shown at arrows 222, 224, 226, as noted above, and at arrows 222a, 224a, 226a. Additional inlet flow is enabled by transverse gaps 214, 244. Additional outlet flow is enabled by transverse gaps 236, 246, 248. In a further embodiment, the flow direction may be reversed such that incoming fluid flow enters the filter at end 54 through flow channels 70 and gaps 236, 246, 248, and exits the filter at end 52 through flow channels 58 and gaps 214, 244.

FIG. 11 shows wall segments 260, 262 of FIG. 2 sealed to each other at upstream ends 64 by hot melt adhesive 264. The hot melt adhesive is applied during the pleating process by applying it to the top and bottom sides of a flat planar filter media sheet which is then pleated, with the hot melt adhesive sealing the upstream and downstream ends of the channels as above described. After the pleating and sealing, the pleat block filter element is sealed in a housing, as above described. In FIG. 12, the noted flow channels at their upstream ends extend along transverse direction 210 between first and second distally opposite entrance sections 266 and 268 at first and second transversely distally opposite pleat tip bend lines 46 and 48. A pleat support 270 is molded to the filter element at the second set of pleat tips 48 and extends laterally across such pleat tips at the upstream ends of the channels. The downstream end sealing structure is comparable. The pleat supports such as 270 are mounted and sealed to the housing, for example at housing sidewalls such as 230, FIG. 3. The channels 58 at pleat tips 48 are evenly spaced because of pleat support 270. The channels as they extend toward pleat tips 46 are subject to the above-noted misalignment, for example tipping as shown at 272, FIG. 13, curvature or bending 274, etc. The ends of the filter are exposed to damage, including upstream ends 64 from incoming debris, or other physical contact. If the edges are damaged, filter restriction could be increased and/or a leak path could be created. The noted hot melt adhesive 264 is applied to both the top and bottom sides of a planar filter media sheet, which is then pleated. The resultant leading and/or trailing edge along the hot melt adhesive may vary in thickness and can increase restriction. The hot melt adhesive step and the sealing step at pleat support 270 are separate operations. The hot melt adhesive is applied during the pleating process, and the seal at pleat support 270 is created during a later operation.

### Present Invention

FIGS. 14-33 illustrate the present invention and use like reference numerals from above where appropriate to facilitate understanding.

FIG. 14 is like FIG. 11 and shows a portion of a filter 300 for filtering fluid flowing along axial flow direction 14 as shown at arrow 202. As above, the filter is provided by a pleated filter element 302 like filter element 44, FIG. 1, having a plurality of pleats defined by wall segments such as 50 extending along transverse direction 210, FIGS. 1, 3, 12, 16, between first and second sets of pleat tips at first and second sets of axially extending bend lines 46 and 48. Transverse direction 210 is perpendicular to axial direction 14. The wall segments define axial flow channels 55 therebetween. The channels have a channel width 304 along lateral direction 212 between respective wall segments such as 260 and 262. Lateral direction 212 is perpendicular to axial direction 14 and perpendicular to transverse direction 210. The wall segments extend between upstream and downstream ends 52 and 54, FIGS. 1, 2. The upstream ends of the wall segments are alternately sealed to each other to define a first set of flow channels 58 having open upstream ends 60, and a second set of flow channels 62 interdigitated with the first set of flow channels 58 and having closed upstream ends 64. The downstream ends 54 of the wall segments 50 are alternately sealed to each other such that the first set of flow channels 58 have closed downstream ends 68, and the second set of flow channels 62 have open downstream ends 70.

A plurality of upstream seal tips such as 306, FIGS. 14-16, alternately seal upstream ends 52 of the wall segments to each other and define the noted first and second sets of flow channels 58 and 62 and also protect the upstream ends of the wall segments from damage from incoming debris. In FIGS. 15 and 16, the seal tips have rounded upstream impact surfaces such as 308 shaped to deflect and guide incoming flow into open upstream ends 60 of the first set of channels 58. The seal tips are preferably formed during molding of pleat support 270, eliminating the noted hot melt adhesive and application thereof during pleating, and providing a combined integral pleat support and seal tip 270 and 306 during the noted later step. This combined structure is shown at 310 in FIG. 16.

Seal tips 306 at least partially encapsulate upstream ends 52 of the wall segments. The seal tips have an impact surface, which may be flat as shown at 312 in FIG. 14, or rounded as shown at 308 in FIG. 15, as well as other shapes, to be described, which impact surface is upstream of the upstream ends 52 of the wall segments and receive the impact of incoming debris as shown at incoming fluid flow arrow 202. The wall segments at their upstream ends have first and second distally oppositely laterally facing channel surfaces 314 and 316. First channel surface 314 laterally faces a respective channel of the first set 58 at open upstream end 60. Second channel surface 316 laterally faces a respective channel of the second set 62 at closed upstream end 64. Upstream end 52 of wall segment 260 has a leading edge 318 extending laterally between first and second channel surfaces 314 and 316. Seal tip 306 has a plurality of encapsulation surfaces downstream of impact surface 312 and sealingly engaging and extending along leading edge surface 318 and at least one of the noted channel surfaces. In FIG. 14, the encapsulation surfaces of seal tip 306 extend along leading edge surface 318 and the noted second channel surface 316 of wall segment 260. In FIG. 14, the encapsulation surfaces of seal tip 306 do not extend along the noted first channel surface 314 of wall segment 260. In FIG. 17, the encapsulation surfaces of seal tip 320 extend along both of the noted first and second channel surfaces 314 and 316 of wall segment 260. In FIG. 18, the encapsulation surfaces of seal tip 322 extend along the noted first channel surface 314 of wall segment 260 and not along second channel surface 316.

In FIG. 14, seal tip 306 has a downstream segment 324 extending axially between adjacent wall segments 260 and 262 and sealingly engaging channel surfaces 316 and 326 on distally opposite sides of downstream segment 324 of the seal tip such that channel surfaces 316 and 326 face each other across the respective channel of the second set 62 at closed upstream end 64 and are separated by downstream segment 324 of seal tip 306 therebetween. Seal tip 306 has an upstream segment 328 extending laterally across and sealingly engaging both of the leading edge surfaces 318 and 330 of adjacent wall segments 260 and 262.

In FIG. 17, seal tip 320 has a first central axially extending downstream segment 332 comparable to segment 324, and has second and third axially extending downstream segments 334 and 336. Downstream segment 334 of the seal tip extends axially along and sealingly engages channel surface 314 of wall segment 260. Downstream segment 336 of the seal tip extends axially along and sealingly engages channel surface 338 of wall segment 262. Downstream segments 334 and 336 of seal tip 320 are laterally spaced on opposite sides of downstream segment 332 of the seal tip therebetweeen.

In FIG. 18, seal tip 322 has a pair of axially extending downstream segments 340 and 342 laterally spaced by adjacent wall segments 260 and 262 therebetween at closed upstream end 64 of a respective channel of the second set 62. Downstream segment 340 of seal tip 322 extends axially along and sealingly engages channel surface 314 of wall segment 260. Downstream segment 342 of seal tip 322 extends axially along and sealingly engages channel surface 338 of wall segment 262. In FIG. 18, channel surfaces 316 and 326 of adjacent wall segments 260 and 262 engage each other at closed upstream end 64.

Seal tip 322, FIG. 18, has three encapsulation surfaces 352, 354, 356 encapsulating adjacent wall segments 260, 262 at closed upstream end 64 of a respective channel of the second set 62. First encapsulation surface 352 extends along channel surface 314 of wall segment 260. Second encapsulation surface 354 extends along leading edge surfaces 318, 330 of adjacent wall segments 260, 262. Third encapsulation surface 356 extends along channel surface 338 of wall segment 262. Seal tip 322 has a U-shape having a lateral bight 344 and a pair of legs 340 and 342 extending axially downstream therefrom. Second encapsulation surface 354 provides the noted bight 344. First and third encapsulation surfaces 352 and 356 provide the noted legs of the U.

Seal tip 306, FIG. 14, has four encapsulation surfaces 358, 360, 362, 364 encapsulating adjacent wall segments 260, 262 at closed upstream end 64 of a respective channel of the second set 62. First encapsulation surface 358 extends along leading edge surface 318 of wall segment 260. Second encapsulation surface 360 extends along channel surface 316 of wall segment 260. Third encapsulation surface 362 extends along channel surface 326 of wall segment 262. Fourth encapsulation surface 364 extends along leading edge surface 330 of wall segment 262. Seal tip 306 has a T-shape having a lateral crossbar 328 and a trunk 324 extending centrally axially downstream therefrom. The noted first and fourth encapsulation surfaces 358 and 364 provide the noted crossbar, and the second and third encapsulation surface 360 and 362 provide the noted trunk.

Seal tip 320, FIG. 17, has six encapsulation surfaces 366, 368, 370, 372, 374, 376 encapsulating adjacent wall segments 260, 262 at closed upstream end 64 of a respective channel of the second set 62. First encapsulation surface 366 extends along channel surface 314 of wall segment 260. Second encapsulation surface 368 extends along leading edge surface 318 of wall segment 260. Third encapsulation surface 370 extends along channel surface 316 of wall segment 260. Fourth encapsulation surface 372 extends along channel surface 326 of wall segment 262. Fifth encapsulation surface 374 extends along leading edge surface 330 of wall segment 262. Sixth encapsulation surface 376 extends along channel surface 338 of wall segment 262. Seal tip 320 has an E-shape having a lateral crossbar 378 and three laterally spaced legs 334, 332, 336 extending axially downstream therefrom. The noted second and fifth encapsulation surfaces 368 and 374 provide the noted crossbar. First encapsulation surface 366 provides a first of the noted legs. Third and fourth encapsulation surfaces 370 and 372 provide a second of the noted legs. Sixth encapsulation surface 376 provides the third of the noted legs.

Seal tips 306, 320, 322 may have flat upstream impact surfaces as shown in FIGS. 14, 17, 18 at 312, 378, 344, or may be shaped to deflect and guide incoming flow into open upstream ends 60 of the first set of channels 58, for example as shown in FIGS. 15, 19-22. In FIG. 15, seal tip 306 has a rounded upstream impact surface 308. In FIG. 19, seal tip 320 has an upstream impact surface which is rounded at 390. In FIG. 20, seal tip 322 has a rounded upstream impact surface 392. In further embodiments, the upstream impact surfaces of the seal tips are pointed and are tapered from a leading point along a tapered ramp surface toward the open upstream ends 60 of the first set of channels 58. For example, in FIG. 21, seal tip 322 has an upstream impact surface 394 tapered from a leading point 396 along a tapered ramp surface 398 to open upstream end 60 of the first set of channels 58. In FIG. 22, seal tip 320 has an upstream impact surface 400 tapered from a leading point 402 along a tapered ramp surface 404. Seal tip 306 may likewise be tapered from a leading point along a tapered ramp surface, for example as shown in FIG. 23 at seal tip 306 tapered from leading point 406 along tapered ramp surface 408.

The seal tips such as 306, FIGS. 16, 23, 24, extend along transverse direction 210 between first and second distally opposite seal tip ends 412 and 414. First seal tip end 412 terminates at a single pleat tip of the noted first set of pleat tips 46. Second seal tip end 414 terminates between a pair of pleat tips of the noted second set of pleat tips 48. Such pair of pleat tips 48 are on opposite lateral sides of second seal tip end 414. Channels 58 at upstream ends 60 extend along transverse direction 210 between the noted first and second distally opposite entrance sections 266 and 268, FIG. 12, respectively. Pleat support 270 supports the pleats at the second set of pleat tips 48 and the second seal tip ends 414. Pleat support 270 extends laterally across the second set of pleat tips 48 at upstream end 60 of the channels and is interconnected with and structurally supports seal tips 306 at second seal tip ends 414, preferably by being integrally molded therewith.

FIG. 24 also shows a support rib 420 extending laterally across upstream ends 60 of the channels and the seal tips 306 and interconnecting and structurally supporting and maintaining uniform lateral spacing of seal tips 306 and wall segments 50 at upstream ends 52. Support rib 420 is spaced transversely between first and second seal tip ends 412 and 414 and extends laterally along direction 212 across the seal tips. FIG. 25 shows a plurality of support ribs 420, 422, 424 transversely spaced from each other and extending laterally across seal tips 306. In the embodiment of FIGS. 24 and 25, the support ribs 420, 422, 424 are flush with seal tips 306 along a lateral and transverse plane. In a further embodiment, FIG. 26, a support rib 426 protrudes axially upstream from seal tips 306. The support ribs are preferably integrally molded with seal tips 306.

FIGS. 27 and 28 show a further embodiment, comparable to that shown in FIGS. 3-10 above. The filter is provided by a plurality of panels of pleated filter elements such as 300, 430. A plurality of sets of upstream pleat tips 306, 432 are provided, one set for each panel. Panels 300 and 430 have a transverse gap 434 therebetween at one of the upstream and downstream ends, as above at upstream gap 214 in FIG. 3, or downstream gap 246 in FIG. 9, and are sealed to each other at the other of the upstream and downstream ends, for example as shown at sealing strip 216 in FIG. 4 and sealing strip 250 in FIG. 8. FIGS. 27 and 28 show transverse gap 434 at the upstream end, which gap provides additional fluid flow axially therethrough. Housing 436, comparable to housing 220, FIG. 3, has transversely spaced sidewalls 438 and 440, comparable to sidewalls 228, 230, FIG. 3, and generally parallel to panels 300, 430. Sidewalls 438 and 440 are spaced transversely on distally opposite sides of the filter. Transverse gap 434 is at upstream end 52 and extends transversely between panels 300 and 430. Seal tips 306 and 432 extend along the noted transverse direction between first and second distally opposite seal tip ends, such as 412 and 414 for seal tips 306, and 442 and 444 for seal tips 432. First seal tip ends 412 and 442 of first and second panels 300 and 430 are separated by transverse gap 434 therebetween at upstream end 52. Seal tip ends 412, 442 terminate at a single pleat tip 46, FIG. 16, of the noted first set of pleat tips. Second seal tip ends 414, 444 of first and second panels 300, 430 terminate between a pair of pleat tips of the second set of pleat tips 48, FIG. 16, at respective sidewalls 438, 440 of the housing. The noted pair of pleat tips are on opposite lateral sides of the second pleat tip end. Channels 58 at upstream ends 60 extend along transverse direction 210 between the noted first and second distally opposite entrance sections 266 and 268, FIG. 12, at the noted first and second seal tip ends 412 and 414, respectively. The entrance sections such as 266 and 446 of the channels transversely face each other across gap 434 and are transversely spaced by gap 434 therebetween. Sidewall pleat supports such as 270, 448 are provided at each of sidewalls 438 and 440 supporting the pleats of the respective panel 300, 430 at the noted second set of pleat tips and the second seal tip ends 414, 444. The sidewall pleat supports such as 270, 448 extend laterally across the second sets of pleat tips at upstream ends 60 of the channels and are interconnected with and structurally support seal tips 306, 432 at the noted second seal tip ends 414, 444.

Seal tips 306 and 432 in FIGS. 27 and 28 are tapered along an inlet angle as shown at 450 and 452 deflecting debris 454, 456 into gap 434. The seal tip inlet angle tapers from upstream to downstream as it extends transversely toward gap 434. The upstream most portion of the seal tip, such as 458, 460, FIG. 28, is proximate a respective sidewall 438, 440, and the downstream most portion of the seal tip, such as 462, 464 is at gap 434. FIG. 29 shows a further embodiment having support ribs such as 466, 468 extending laterally across the upstream ends of the channels and the seal tips 306, 432.

In FIGS. 30-32, incoming debris is deflected toward outside gaps, rather than a central gap. Housing 436a has first and second transversely spaced sidewalls 438a and 440a generally parallel to first and second panels of pleated filter elements 300a, 430a. Sidewalls 438a, 440a are spaced transversely on distally opposite sides of the filter. Transverse gap 434a, FIG. 32, is a central gap and is at the downstream end of the filter. First and second outer gaps 480 and 482 are provided between a respective sidewall 438a and 440a and a respective panel 300a and 430a. First and second outer gaps 480 and 482 are at the upstream end of the filter and are open thereat, and are closed at the downstream end of the filter by sealing strips such as 216a, 216b, comparable to above noted sealing strip 216. Seal tips 306a, 432a are tapered along respective inlet angles 450a and 452a, FIG. 32, deflecting debris 454a, 456a into respective first and second outer gaps 480 and 482. First set of seal tips 306a for first panel 300a has a first seal tip inlet angle 450a tapering from upstream to downstream as it extends transversely toward first outer gap 480. Second set of seal tips 432a for second panel 430a has a second seal tip inlet angle 452a tapering from upstream to downstream as it extends transversely toward second outer gap 482. A central wall pleat support 484, FIG. 30, is located transversely between first and second panels 300a and 430a and supports the pleats of the panels at the noted second sets of pleat tips and second seal tip ends 414a, 444a. Central wall pleat support 484 extends laterally across (i.e. up-down in FIG. 30) the second sets of pleat tips at the upstream ends of the channels. Seal tips 306a, 432a, extend along the noted tapered inlet angles 450a, 452a such that the upstream most portion 458a of the first set of seal tips 306a is proximate central wall 484, the downstream most portion 462a of the first set of seal tips 306a is at first outer gap 480, the upstream most portion 460a of the second set of seal tips 432a is proximate central wall 484, and the downstream most portion 464a of the second set of seal tips 432a is at second outer gap 482.

As above noted, the fluid to be filtered, such as air, may flow in the opposite direction as shown, as noted above in conjunction with FIGS. 5 and 10, wherein it is noted that the flow direction may be reversed such that fluid flows right to left in the orientation in FIGS. 5, 10. This is further illustrated in FIG. 33 showing housing 220a receiving incoming fluid flow at 222a through outer gaps 236a, 238a and passing the fluid through pleated panel filter elements 206a, 208a to central gap 214a for discharge at the downstream end as shown at 226a. Each of the upstream and downstream ends 52a and 54a of the pleated panel filter elements may be sealed by the sealing tip construction disclosed above.

In the preferred embodiment, the sealing mechanism provided by the noted seal tips is a rigid encapsulating sealing mechanism, though softer, flexible sealing mechanisms may also be used and provide many of the above noted advantages. The seal tips are preferably formed by injection molding, though other types of processes, including molding processes, may be used. The noted upstream seal tips preferably: a) alternately seal the upstream ends of the wall segments to each other to define the noted first and second sets of flow channels; b) protect the upstream ends of the wall segments from damage from incoming debris; c) provide structural support, preferably rigid structural support, withstanding incoming high air flow rates; and d) improve air flow by means of the geometry of the seal, e.g. providing different sealing shapes acting as flow straighteners reducing pressure drop. The encapsulating sealing mechanism maintains a preferably rigid channel width between the pleats which reduces pressure drop. The sealing mechanism can be tilted, FIGS. 27-29, to improve air flow and deflect larger particles into the larger middle channel 434 thus preventing the larger particles from clogging the smaller channels, or can be tilted, FIGS. 30-32, to deflect larger particles into larger outer channels or gaps 480, 482.

It is recognized that various equivalents, alternatives and modifications are possible within the scope of the appended claims.

What is claimed is:

1. A filter for filtering fluid flowing along an axial flow direction comprising a pleated filter element having a plurality of pleats defined by wall segments extending along a transverse direction between first and second sets of pleat tips at first and second sets of axially extending bend lines, said transverse direction being perpendicular to said axial direction, said wall segments defining axial flow channels therebetween, said channels having a channel width extending along a lateral direction between respective wall segments, said lateral direction being perpendicular to said axial direction and perpendicular to said transverse direction, said wall segments extending axially between upstream and downstream ends, said upstream ends of said wall segments being alternately sealed to each other to define a first set of flow channels having open upstream ends, and a second set of flow channels interdigitated with said first set of flow channels and having closed upstream ends, said downstream ends of said wall segments being alternately sealed to each other such that said first set of flow channels have closed downstream ends, and said second set of flow channels have open downstream ends, a plurality of seal tips:
a) alternately sealing at least one of
a1) a set of said upstream ends of said wall segments to each other to define said first and second sets of flow channels, and
a2) a set of said downstream ends of said wall segments to each other to define said first and second sets of flow channels; and
b) protecting the sealed ends of said wall segments from damage.

2. The filter according to claim 1 wherein said seal tips further:
c) provide structural support withstanding high fluid flow rates; and
d) improve fluid flow by means of the geometry of said seal tips.

3. The filter according to claim 2 wherein one or more of said seal tips have a designated said geometry providing a sealing shape acting as a flow straightener reducing pressure drop.

4. The filter according to claim 1 wherein said seal tips at least partially encapsulate said ends of said wall segments.

5. The filter according to claim 1 wherein said seal tips alternately seal said upstream ends of said wall segments to each other.

6. The filter according to claim 1 wherein said seal tips alternately seal said downstream ends of said wall segments to each other.

7. The filter according to claim 1 comprising a first set of said seal tips alternately sealing said upstream ends of said wall segments to each other, and a second set of said seal tips alternately sealing said downstream ends of said wall segments to each other.

8. The filter according to claim 1 wherein said seal tips alternately seal said upstream ends of said wall segments to each other and at least partially encapsulate said upstream ends of said wall segments and have an impact surface upstream of said upstream ends of said wall segments and receiving the impact of incoming debris.

9. The filter according to claim 8 wherein said wall segments at said upstream ends have first and second distally oppositely laterally facing channel surfaces, said first channel surface laterally facing a respective said channel of said first set at said open upstream end, said second channel surface laterally facing a respective said channel of said second set at said closed upstream end, said upstream end of said wall segment having a leading edge surface extending laterally between said first and second channel surfaces, and wherein said seal tips have a plurality of encapsulation surfaces downstream of said impact surface and sealingly engaging and extending along said leading edge surface and at least one of said channel surfaces.

10. The filter according to claim 9 wherein said encapsulation surfaces of said seal tips extend along said second channel surfaces of said wall segments.

11. The filter according to claim 9 wherein said encapsulation surfaces of said seal tips extend along said second channel surfaces of said wall segments and not along said first channel surfaces of said wall segments.

12. The filter according to claim 9 wherein said encapsulation surfaces of said seal tips extend along said first channel surfaces of said wall segments.

13. The filter according to claim 9 wherein said encapsulation surfaces of said seal tips extend along said first channel surfaces of said wall segments and not along said second channel surfaces of said wall segments.

14. The filter according to claim 9 wherein said encapsulation surfaces of said seal tips extend along said both said first and second channel surfaces of said wall segments.

15. The filter according to claim 9 wherein each said seal tip has a downstream segment extending axially between adjacent wall segments and sealingly engaging said second channel surfaces on distally opposite sides of said downstream segment of said seal tip such that said second channel surfaces face each other across said channel of said second set at said closed upstream end and are separated by said downstream segment of said seal tip therebetween, and wherein said seal tip has an upstream segment extending laterally across and sealingly engaging both of said leading edge surfaces of said adjacent wall segments.

16. The filter according to claim 15 wherein each said seal tip has second and third axially extending downstream segments, said second downstream segment extending axially along and sealingly engaging said first channel surface of one of said adjacent wall segments, said third downstream segment extending axially along and sealingly engaging said first channel surface of the other of said adjacent wall segments, said second and third downstream segments of said seal tip being laterally spaced on opposite sides of said first mentioned downstream segment of said seal tip therebetween.

17. The filter according to claim 9 wherein each said seal tip has a pair of axially extending downstream segments laterally spaced by adjacent wall segments therebetween at said closed upstream end of a respective said channel of said second set, one of said downstream segments of said seal tip extending axially along and sealingly engaging said first channel surface of one of said adjacent wall segments, the other of said downstream segments of said seal tip extending axially along and sealingly engaging said first channel surface of the other of said adjacent wall segments.

18. The filter according to claim 17 wherein said second channel surfaces of said adjacent wall segments engage each other at said closed upstream end.

19. The filter according to claim 9 wherein each said seal tip comprises three said encapsulation surfaces encapsulating adjacent wall segments at said closed upstream end of a respective channel of said second set, comprising a first encapsulation surface extending along said first channel surface of one of said adjacent wall segments, a second encapsulation surface extending along said leading edge surfaces of said adjacent wall segments, and a third encapsulation surface extending along said first channel surface of the other of said adjacent wall segments.

20. The filter according to claim 19 wherein said seal tip has a U-shape having a lateral bight and a pair of legs extending axially downstream therefrom, said second encapsulation surface providing said bight, said first and third encapsulation surfaces providing said legs.

21. The filter according to claim 9 wherein each said seal tip comprises four said encapsulation surfaces encapsulating adjacent wall segments at said closed upstream end of a respective channel of said second set, comprising a first encapsulation surface extending along said leading edge surface of one of said adjacent wall segments, a second encapsulation surface extending along said second channel surface of said one adjacent wall segment, a third encapsulation surface extending along said second channel surface of the other of said adjacent wall segments, and a fourth encapsulation surface extending along said leading edge surface of said other adjacent wall segment.

22. The filter according to claim 21 wherein said seal tip has a T-shape having a lateral crossbar and a trunk extending centrally axially downstream therefrom, said first and fourth encapsulation surfaces providing said crossbar, said second and third encapsulation surfaces providing said trunk.

23. The filter according to claim 9 wherein each said seal tip comprises six said encapsulation surfaces encapsulating adjacent wall segments at said closed upstream end of a respective channel of said second set, comprising a first encapsulation surface extending along said first channel surface of one of said adjacent wall segments, a second encapsulation surface extending along said leading edge surface of said one adjacent wall segment, a third encapsulation surface extending along said second channel surface of said one adjacent wall segment, a fourth encapsulation surface extending along said second channel surface of the other of said adjacent wall segments, a fifth encapsulation surface extending along said leading edge surface of said other adjacent wall segment, and a sixth encapsulation surface extending along said first channel surface of said other adjacent wall segment.

24. The filter according to claim 23 wherein said seal tip has an E-shape having a lateral crossbar and three laterally spaced legs extending axially downstream therefrom, said second and fifth encapsulation surfaces providing said crossbar, said first encapsulation surface providing a first of said legs, said third and fourth encapsulation surfaces providing a second of said legs, said sixth encapsulation surface providing the third of said legs.

25. The filter according to claim 8 wherein said impact surfaces of said seal tips are shaped to deflect and guide incoming flow into said open upstream ends of said first set of channels.

26. The filter according to claim 25 wherein said impact surfaces of said seal tips are rounded.

27. The filter according to claim 25 wherein said impact surfaces of said seal tips are tapered from a leading point along a tapered ramp surface toward said open upstream ends of said first set of channels.

28. The filter according to claim 4 wherein said seal tips extend along said transverse direction between first and second distally opposite seal tip ends.

29. The filter according to claim 28 wherein said first seal tip end terminates at a single pleat tip of said first set of pleat tips, and said second seal tip end terminates between a pair of pleat tips of said second set of pleat tips, said pair of pleat tips being on opposite lateral sides of said second seal tip end.

30. The filter according to claim 29 wherein said channels extend along said transverse direction between first and second distally opposite sections at said first and second seal tip ends, respectively, and comprising a pleat support supporting said pleats at said second set of pleat tips and said second seal tip ends.

31. The filter according to claim 30 wherein said pleat support extends laterally across said second set of pleat tips and is interconnected with and structurally supports said seal tips at said second seal tip ends.

32. The filter according to claim 4 comprising a support rib extending laterally across said channels and said seal tips and interconnecting and structurally supporting and maintaining uniform lateral spacing of said seal tips and said wall segments.

33. The filter according to claim 32 wherein said seal tips extend along said transverse direction between first and second distally opposite seal tip ends, and said support rib is spaced transversely between said first and second seal tip ends and extends laterally across said seal tips.

34. The filter according to claim 33 comprising a plurality of said support ribs transversely spaced from each other and extending laterally across said seal tips.

35. The filter according to claim 32 wherein said support rib is flush with said seal tips along a lateral and transverse plane.

36. The filter according to claim 32 wherein said support rib protrudes axially from said seal tips.

37. The filter according to claim 8 comprising a plurality of panels of said pleated filter elements, each panel having a plurality of pleats defined by wall segments extending along said transverse direction between first and second sets of pleat tips at first and second sets of axially extending bend lines, said transverse direction being perpendicular to said axial direction, said wall segments defining axial flow channels therebetween, said channels having a channel width extending along said lateral direction between respective wall segments, said lateral direction being perpendicular to said axial direction and perpendicular to said transverse direction, said wall segments extending axially between upstream and downstream ends, said upstream ends of said wall segments being alternately sealed to each other to define a first set of flow channels having open upstream ends, and a second set of flow channels interdigitated with said first set of flow channels and having closed upstream ends, said downstream ends of said wall segments being alternately sealed to each other such that said first set of flow channels have closed downstream ends, and said second set of flow channels have open downstream ends, such that fluid to be filtered flows substantially directly axially through said filter, through said open upstream ends of said first set of flow channels then through said wall segments then through said open downstream ends of said second set of flow channels, a plurality of sets of said upstream seal tips, one set for each said panel, a first and a second of said panels having a transverse gap therebetween at one of said upstream and downstream ends and being sealed to each other at the other of said upstream and downstream ends, said gap providing additional fluid flow axially therethrough.

38. The filter according to claim 37 comprising a housing having first and second transversely spaced sidewalls generally parallel to said panels, said first and second sidewalls being spaced transversely on distally opposite sides of said filter, wherein said gap is at said upstream end and extends transversely between said panels, said seal tips extend along said transverse direction between first and second distally opposite seal tip ends, said first seal tip ends of said first and second panels transversely face each other across said gap and are separated by said gap therebetween at said upstream end, said first seal tip ends of said first and second panels terminate at a single pleat tip of said first sets of pleat tips, and said second seal tip ends of said first and second panels terminate between a pair of pleat tips of said second sets of pleat tips at said first and second sidewalls of said housing, respectively, said pair of pleat tips are on opposite lateral sides of said second pleat tip end, said channels at said upstream ends extend along said transverse direction between first and second distally opposite entrance sections at said first and second seal tips ends, respectively, said first entrance sections transversely facing each other across said gap and transversely spaced by said gap therebetween, a sidewall pleat support at each of said sidewalls and supporting said pleats of the respective said panel at said second set of pleat tips and said second seal tip ends, said sidewall pleat supports extend laterally across said second sets of pleat tips at said upstream ends of said channels and are interconnected with and structurally support said seal tips at said second seal tip ends.

39. The filter according to claim 37 wherein said gap is at said upstream end, and said seal tips are tapered along an inlet angle deflecting debris into said gap.

40. The filter according to claim 39 wherein said seal tip inlet angle tapers from upstream to downstream as it extends transversely toward said gap.

41. The filter according to claim 40 comprising a housing having first and second transversely spaced sidewalls generally parallel to said panels, said first and second sidewalls being spaced transversely on distally opposite sides of said filter, said seal tips extending along said tapered inlet angle such that the upstream most portion of said seal tip is proximate a respective said sidewall, and the downstream most portion of said seal tip is at said gap.

42. The filter according to claim 37 comprising a housing having first and second transversely spaced sidewalls generally parallel to said panels, said first and second sidewalls being on transversely distally opposite sides of said filter, wherein said gap is a central gap and is at said downstream end, and comprising first and second outer gaps between a respective said sidewall and a respective said panel, said first and second outer gaps being at said upstream end, and said seal tips are tapered along inlet angles deflecting debris into said first and second outer gaps.

43. The filter according to claim 42 comprising a first set of said seal tips for a first of said panels and having a first seal tip inlet angle tapering from upstream to downstream as it extends transversely toward said first outer gap, and a second set of said seal tips for a second of said panels and having a second seal tip inlet angle tapering from upstream to downstream as it extends transversely toward said second outer gap.

44. The filter according to claim 43 comprising a central wall pleat support transversely between said first and second panels and supporting said pleats of said panels at said second sets of pleat tips and said second seal tip ends, said central wall pleat support extending laterally across said second sets of pleat tips at said upstream ends of said channels, said seal tips extending along said tapered inlet angles such that the upstream most portion of said first set of seal tips is proximate said central wall, the downstream most portion of said first set of seal tips is at said first outer gap, the upstream most portion of said second set of seal tips is proximate said central wall, and the downstream most portion of said second set of seal tips is at said second outer gap.

45. A filter for filtering fluid flowing along an axial flow direction comprising a pleated filter element having a plurality of pleats defined by wall segments extending along a transverse direction between first and second sets of pleat tips at first and second sets of axially extending bend lines, said transverse direction being perpendicular to said axial direction, said wall segments defining axial flow channels therebetween, said channels having a channel width extending along a lateral direction between respective wall segments, said lateral direction being perpendicular to said axial direction and perpendicular to said transverse direction, said wall segments extending axially between upstream and downstream ends, said upstream ends of said wall segments being alternately sealed to each other to define a first set of flow channels having open upstream ends, and a second set of flow channels interdigitated with said first set of flow channels and having closed upstream ends, said downstream ends of said wall segments being alternately sealed to each other such that said first set of flow channels have closed downstream ends, and said second set of flow channels have open downstream ends, a combined pleat support and seal tip member extending laterally across said second set of pleat tips at at least one of said upstream and downstream ends of said channels and having a plurality of seal tips extending transversely therefrom along said ends of said wall segments and alternately sealing said ends of said wall segments to each other to define said first and second sets of flow channels.

46. The filter according to claim 45 wherein said seal tips extend along said transverse direction between first and second distally opposite seal tip ends, said first seal tip end terminating at a single pleat tip of said first set of pleat tips, said second seal tip end terminating between a pair of pleat tips of said second set of pleat tips, said pair of pleat tips being on opposite lateral sides of said second seal tip end, said channels extending along said transverse direction between first and second distally opposite sections at said first and second seal tip ends, respectively, said combined pleat support and seal tip member supporting said pleats at said second set of pleat tips at said second seal tip ends.
